(19) United States
(12) Patent Application Publication
(10) Pub. No.: US 2011/0285172 A1
(43) Pub. Date: Nov. 24, 2011

(54) Body Structure and Beam Assembly

(75) Inventors: Jeffrey M. Scramlin, Macomb, MI (US); Kenneth G. Danaj, Sterling Heights, MI (US); Mark J. Yergin, Novi, MI (US); Sarah J. Pike, Warren, MI (US)

(73) Assignee: GM GLOBAL TECHNOLOGY OPERATIONS, INC., Detroit, MI (US)

(21) Appl. No.: 12/785,550

(22) Filed: May 24, 2010

(51) Int. Cl. B62D 25/02; B21D 53/88

(52) U.S. Cl. 296/191; 29/897.2

(57) ABSTRACT

A body structure and beam assembly for use in a vehicle, and a method of making the assembly. The body structure and beam assembly including a body panel; a beam including an attachment portion, with the attachment portion including a non-engagement portion that is adjacent to but spaced from the body panel and multiple spaced apart local weld depressions extending out of plane from the non-engagement portion, with each of the local weld depressions in contact with the body panel; and multiple separate welds securing the body panel to the beam, each of the welds located at a respective one of the local weld depressions.

### BACKGROUND OF INVENTION

The present invention relates generally to welded beams employed in vehicles and more particularly to the configuration of the beam at the location of welds that secure the beam to the vehicle body.

It is common for different parts of an automotive vehicle body to be welded together, particularly with spot welds. For example, a side door impact beam is typically welded to a door inner panel for a vehicle side door. Each end of the impact beam has large generally flat areas that are in contact with the door inner panel, with a series of separate welds made at spaced apart locations in these flat areas. A drawback with this weld interface is the potential for corrosion between the flat areas and the adjacent area of the door inner panel, even when the body has undergone an anticorrosion bath. To avoid this corrosion concern, then, some coat or galvanize the impact beam before attachment to the body and the vehicle undergoing the anticorrosion bath. However this is more costly than desirable and may add an additional step to the fabrication and assembly process.

### SUMMARY OF INVENTION

An embodiment contemplates a body structure and beam assembly for use in a vehicle comprising: a body panel; a beam including an attachment portion, the attachment portion including a non-engagement portion that is adjacent to but spaced from the body panel and multiple spaced apart local weld depressions extending out of plane from the non-engagement portion, with each of the local weld depressions in contact with the body panel; and multiple separate welds securing the body panel to the beam, with each of the welds located at a respective one of the local weld depressions.

An embodiment contemplates a method of making a body structure and beam assembly for use in a vehicle, the method comprising the steps of: stamping local weld depressions in an attachment portion of the beam that are out of plane from a non-engagement portion of the attachment portion; aligning the beam with the body structure such that the local weld depressions are in contact with the body structure and the non-engagement portion is spaced from the body structure to form a gap; placing a respective one of a plurality of welds at each of the local welding depressions to thereby secure the beam to the body structure; and dipping the body structure and beam assembly in an anticorrosion bath, whereby an anticorrosion coating will be applied to the body structure and beam assembly, including a surface of the non-engagement portion facing the body structure.

An advantage of an embodiment is that the body structure and beam assembly have the local weld depressions, with the non-engagement portions between them, which helps to avoid corrosion concerns between the body structure and beam. An anticorrosion bath the vehicle body undergoes allows for the anticorrosion coating to coat the non-engagement portions facing the adjacent body structure. This allows for attachment of the beam to the body structure without the need for separate coating, galvanization or the use of a weld-through sealer, which results in lower overall costs of fabrication and assembly. This is particularly useful when employed to secure a side door impact beam to a door inner panel in a side door of an automotive vehicle.

### BRIEF DESCRIPTION OF DRAWINGS

FIG. 1 is an elevation view of a portion of a beam mounted on body structure.

FIG. 2 is another portion of the beam and body structure.

FIG. 3 is a section view taken along line 3-3 in FIG. 2.

### DETAILED DESCRIPTION

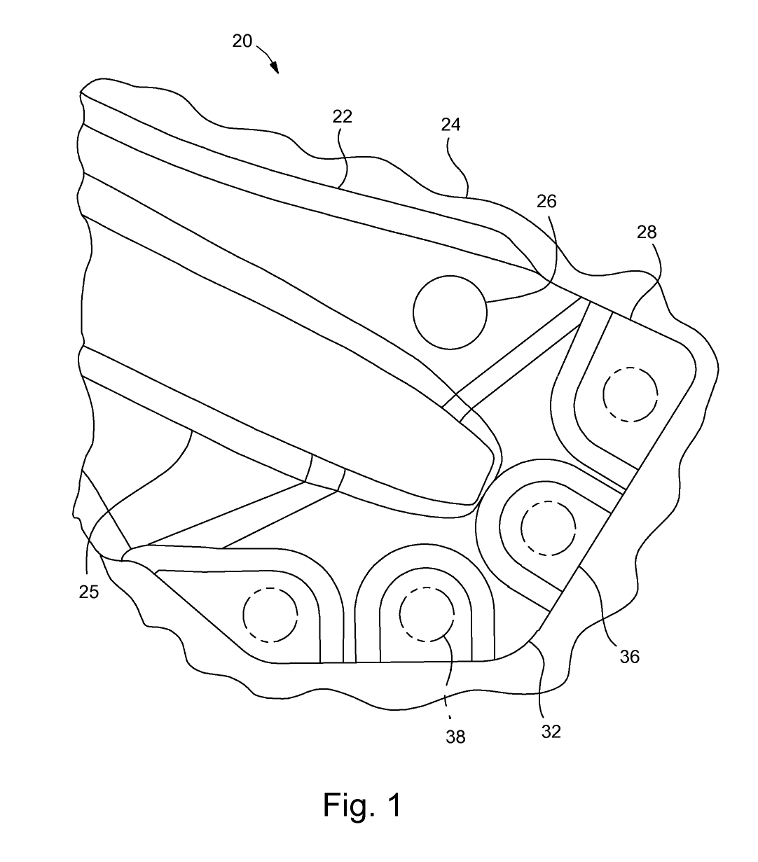

Referring to FIGS. 1-3, portions of a body structure and beam assembly, indicated generally at 20, are shown. The assembly 20 is employed on a vehicle and includes a beam 22 that is welded to a body panel 24. The beam 22 may be, for example, a side door impact beam, and the body panel 24 may be, for example, a door inner panel of a vehicle door.

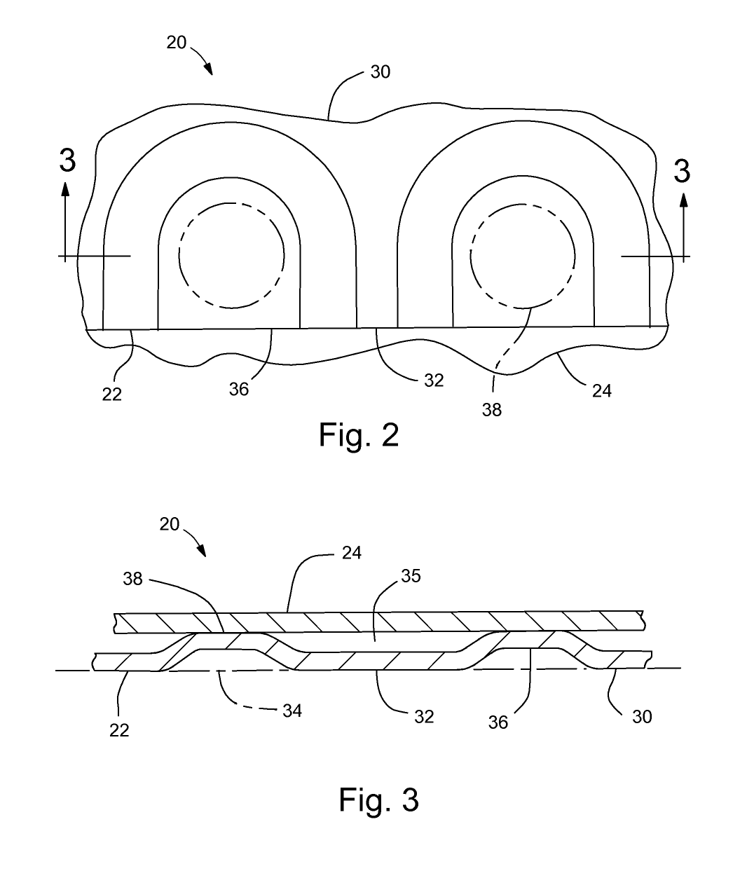

The beam 22 may be made of, for example, steel, and may be formed by a stamping operation. The beam 22 may include common features such as a stiffening bead 25 and a hole 26 (shown in FIG. 1). The beam 22 may also include a first attachment portion 28 (shown in FIG. 1) and a second attachment portion 30 (shown in FIGS. 2 and 3). The attachment portions 28, 30 are portions of the beam 22 where the beam 22 is secured to the body panel 24. Each attachment portion 30 includes a non-engagement portion 32 that may be in the general plane 34 of the beam 22. These non-engagement portions 32 are adjacent to the body panel 24 but are spaced from the body panel 24 (best seen in FIG. 3), creating a gap 35 between the two at these locations. Also located within each attachment portion 30 are local weld depressions 36. Each local weld depression 36 is separated from other weld depressions by non-engagement portions 32. Each local weld depression 36 is in contact with the body panel 24 and is sized to be large enough to receive a weld.

The beam 22 is secured to the body panel 24 with welds 38 at weld locations within each of the local weld depressions 36. These may be spot welds. The beam 22 and body panel 24 may then be coated, such as with an anti-corrosion bath. By only having contact between the beam 22 and the body panel 24 at the individual welds 38, the non-engagement portions 32 (and the portions of the body panel 24 adjacent to the non-engagement portions 32) can receive the anti-corrosion coating on both sides of the material when the vehicle body undergoes a coating process, such as, for, example, an electroplating operation (ELPO) bath. With the reduction in mating surface area of the beam 22 and body panel 24 interface, which allows for this increased corrosion protection, better resistance to corrosion is achieved. The particular chemical make up of the anticorrosion coating applied is well known to those skilled in the art and so will not be discussed in detail herein.

If the beam 22 is a side door impact beam and the body panel 24 is a door inner panel on an automotive vehicle, then the spacing of the non-engagement portions 32 from the door inner panel may create, for example, a gap 35 of about two millimeters. Also, with this example, the local weld depressions 36 may have, for example, a width of the flat contact portion of about fourteen millimeters to allow for creation of the welds 38 at the weld locations. The welds 38 may each be spaced apart, for example, a minimum distance of at least thirteen millimeters between the centers of adjacent weld points in order to assure that the corrosion material in an ELPO bath will properly coat the door impact beam and door inner panel.

While certain embodiments of the present invention have been described in detail, those familiar with the art to which this invention relates will recognize various alternative designs and embodiments for practicing the invention as defined by the following claims.

What is claimed is:

1. A body structure and beam assembly for use in a vehicle comprising:
a body panel;
a beam including an attachment portion, the attachment portion including a non-engagement portion that is adjacent to but spaced from the body panel to create a gap therebetween and a plurality of spaced apart local weld depressions extending out of plane from the non-engagement portion, each of the local weld depressions in contact with the body panel; and
a plurality of separate welds securing the body panel to the beam, each of the welds located at a respective one of the local weld depressions.

2. The body structure and beam assembly of claim 1 wherein the body panel is a door inner panel and the beam is a side door impact beam.

3. The body structure and beam assembly of claim 1 wherein the gap is approximately two millimeters wide.

4. The body structure and beam assembly of claim 1 wherein the beam and the body panel are made of steel.

5. The body structure and beam assembly of claim 1 wherein the body panel and the beam have an anticorrosion coating, wherein the anticorrosion coating is applied after the beam is welded to the body panel.

6. The body structure and beam assembly of claim 5 wherein the coating covers a surface of the non-engagement portion facing the body panel.

7. A method of making a body structure and beam assembly for use in a vehicle, the method comprising the steps of:
(a) stamping local weld depressions in an attachment portion of the beam that are out of plane from a non-engagement portion of the attachment portion;
(b) aligning the beam with the body structure such that the local weld depressions are in contact with the body structure and the non-engagement portion is spaced from the body structure to form a gap;
(c) placing a respective one of a plurality of welds at each of the local welding depressions to thereby secure the beam to the body structure; and
(d) dipping the body structure and beam assembly in an anticorrosion bath, whereby an anticorrosion coating will be applied to the body structure and beam assembly, including a surface of the non-engagement portion facing the body structure.

8. The method of claim 7 wherein step (b) is further defined by the gap being about two millimeters wide.

9. The method of claim 7 wherein step (c) is further defined by the welds being spot welds.

10. The method of claim 7 wherein the body structure is a door inner panel and the beam is a side door impact beam.
